(19) United States
(12) Patent Application Publication
(10) Pub. No.: US 2009/0094597 A1
(43) Pub. Date: Apr. 9, 2009

(54) Portable firmware device

(75) Inventors: Victor Moskalik, Ottawa (CA); Laurence Hamid, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Memory Experts International Inc., Montreal (CA)

(21) Appl. No.: 12/285,333

(22) Filed: Oct. 2, 2008

Related U.S. Application Data
(60) Provisional application No. 60/960,571, filed on Oct. 4, 2007.

(51) Int. Cl. G06F 9/445; G06F 12/14; G06F 12/00

(52) U.S. Cl. 717/174; 711/115; 713/193; 711/E12.092

(57) ABSTRACT

A method of providing new functionality to an electronic product is provided. The new functionality for the electronic product being installed via a new firmware load from a memory card. The new firmware load being released to the electronic product upon the provision of an authentication by the user of the electronic product that matches the authentification credentials stored within the memory card. In a further embodiment of the invention the authentication further supports the transfer of additional content relating to the authenticated user thereby providing the electronic device with a “personality” determined by the user. In another embodiment of the invention the new firmware load is “personalized” to the memory card such that it cannot be illegally duplicated or copied thereby allowing vendors to provide via the Internet new functionalities for electronic products on a procurement basis.

### FIELD OF THE INVENTION

The invention relates to the field of electronic devices and more particularly to a method of providing firmware to a processor based electronic device.

### BACKGROUND OF THE INVENTION

Microprocessor controlled electronic devices are ubiquitous. Some examples include personal computers, laptop computers, Personal Digital Assistants, cellular telephones, audio-visual players such as MP3 or DVD, gaming consoles including portable devices, cameras, portable memory storage devices, and video recorders. Typically, each of these electronic products includes a microprocessor, a read-only memory (ROM) that has firmware stored therein and random access memory (RAM). When the device is powered up the microprocessor loads the firmware from the ROM into a memory store internal to the microprocessor for execution. In many instances once the firmware is loaded, the ROM is not accessed again until the device is powered up again because the ROM's sole purpose is providing the firmware to the processor. In other instances, typically portable systems and microcontroller applications, the firmware instructions are fetched directly from ROM as required without loading a firmware image into RAM. In these latter systems the ROM is generally mapped to the microcontroller memory space. Once the firmware is executed the electronic product provides functionality and interfaces as defined by the firmware in conjunction with the hardware.

The firmware plays an important role in today's electronic products in respect of not only their functionality, but the ability to correct defects and modify performance after product release. It is not uncommon for manufacturers to identify subsequent failings in their firmware as released, or to seek to provide users with improvements to firmware. In such instances the manufacturer typically places firmware upgrades onto their website, but they do not communicate the existence of these to the owners of the electronic products affected.

In other instances it may be advantageous to provide an electronic product with two or more firmware loads, such as for example an MP3 player wherein a “child” firmware load provides only the ability to play or shuffle music and an “adult” firmware load that provides additional features such as uploading new music, deleting music, and allowing playback of music with an “explicit” rating. Such functionality is not supported today within electronic products that have single firmware loads.

It would be advantageous to provide a method and system for firmware management that overcomes at least some of the above-mentioned limitations of the prior art.

### SUMMARY OF THE INVENTION

In accordance with an aspect of the invention there is provided a method of modifying the functionality of an electronic product comprising:
(a) providing an electronic product, the electronic product comprising a microprocessor, a volatile memory for storing firmware to be executed by the microprocessor, a memory card interface according to a first standard, and a communications interface according to a second standard, the second standard being different than the first standard;
(b) inserting into the memory card interface a memory card according to the first standard, the memory card having stored thereon a firmware load;
(c) transferring the firmware load from the memory card to the volatile memory of the electronic product via the memory card interface; and
(d) using the microprocessor of the electronic product, executing the firmware load in the volatile memory so as to thereby establish a configuration of the electronic product.

In accordance with an aspect of the invention there is provided a method of configuring an electronic product comprising transferring a firmware load stored on a memory card to a volatile memory of an electronic product via an interface in communication with the volatile memory, the volatile memory for storing a firmware load for execution by a microprocessor forming part of the electronic product.

In accordance with an aspect of the invention there is provided a method of configuring an electronic product comprising:
(a) providing a vendor site connected to a network, the vendor site allowing a user to browse at least one new functionality of a plurality of new functionalities, each of the plurality of new functionalities relating to an electronic product comprising at least a first card reader and characterized by at least a serial number;
(b) interfacing a memory card associated with the user to the network, the memory card compatible with the card reader and having a personal identity;
(c) purchasing from the vendor site the at least one new functionality of the plurality of new functionalities; and
(d) transferring to the memory card from the vendor site via the network new firmware relating to the purchase, the provided new firmware being personalized to at least one of the serial number and personal identity and when executed by the electronic product providing the purchased at least one new functionality of the plurality of new functionalities.

### BRIEF DESCRIPTION OF THE DRAWINGS

Exemplary embodiments of the invention will now be described in conjunction with the following drawings, in which:

FIG. 1 illustrates a portable memory storage device with Secure Digital (SD) and Universal Serial Bus (USB) interfaces that is reconfigurable by external firmware loads according to the invention.

FIG. 2 illustrates a portable memory storage device with SD and USB interfaces supporting encrypted firmware loading that is reconfigurable by external firmware loads according to an embodiment of the invention.

FIG. 3 illustrates a portable memory storage device with SD and USB interfaces supporting selection of firmware from multiple firmware files stored in the memory storage device that is reconfigurable by external firmware loads according to an embodiment of the invention.

FIG. 4 illustrates a portable memory storage device with SD and USB interfaces supporting selection of encrypted firmware from multiple encrypted firmware files stored in the memory storage device that is reconfigurable by external firmware loads according to an embodiment of the invention.

FIG. 5 illustrates a portable multimedia device incorporating SD and USB interfaces that is reconfigurable by external firmware loads according to an embodiment of the invention.

FIG. 6 illustrates a computer security device incorporating SD and USB interfaces that is reconfigurable by external firmware loads according to an embodiment of the invention.

FIG. 7 illustrates a gaming console incorporating SD, USB, and Ethernet interfaces that is reconfigurable by external firmware loads according to an embodiment of the invention.

### DETAILED DESCRIPTION OF EMBODIMENTS OF THE INVENTION

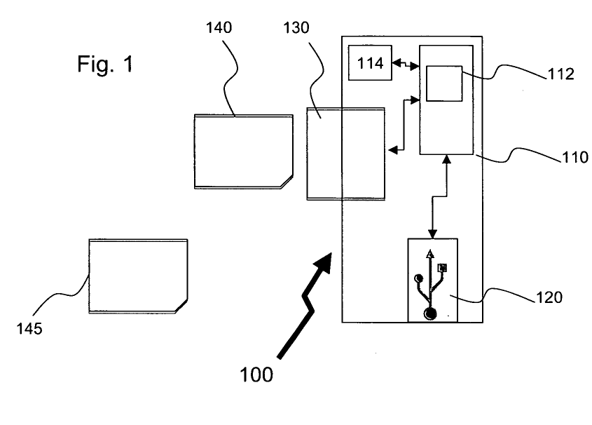

The invention is described below in reference to FIGS. 1 through 7. These embodiments for ease of presentation are described in four categories. These categories being:
a single firmware scenario that addresses an electronic device loading a single application upon power-up or rebooting;
a single encrypted firmware load wherein the firmware load is encrypted within memory and is decrypted upon loading during the initialization of the electronic device;
a multiple firmware scenario wherein the electronic device has a plurality of firmware options available at initialization; and
a multiple encrypted firmware scenario wherein the multiple firmware options available are encrypted in memory and only the selected firmware option is decrypted to initialize the electronic product

It will be apparent that combinations other than the above-mentioned, non-limiting examples are within the scope of the instant invention, such as for instance multiple firmware options of which a predetermined portion of the firmware options are encrypted and the remainder are non-encrypted. Whilst not explicitly addressed, it will nevertheless be apparent to one skilled in the art from the exemplary embodiments how such combinations may be provisioned and implemented.

Single Firmware: Referring to FIG. 1 shown is a portable memory storage device 100 comprising a peripheral interface in the form of a USB interface 120, a processor 110, and a secondary interface 130. The secondary interface 130 is in the form of a memory card interface, for example an interface for a Secure Digital (SD) memory card 140. Alternatively, another interface for another memory card format is used.

In practice, a SD memory card 140 is coupled with the secondary interface 130 and the portable memory storage device 100 is then coupled with a host system, not shown for clarity. The portable memory storage device 100 is compliant with a Universal Serial Bus standard, for example USB 1.1 or USB 2.0, operating at 5±0.25 volts and drawing power from the host system. On connection to the host system the portable memory storage device 100 powers itself up, at which point the processor 110 retrieves firmware from within the flash memory of the SD memory card 140, and stores it in the volatile memory 112 of processor 110. The firmware is then executed and causes the memory storage device 100 to operate according to the design thereof. Thus, the memory card 140 has the firmware stored therein and insertion of an alternate memory card 145 into second interface results in the processor 110 loading and executing different firmware. For example, a function similar to a firmware upgrade is provided by providing a new alternate memory card 145. In this embodiment the firmware is not “upgraded” in the conventional sense as it is not copied and stored in a non-volatile memory 114 associated with the processor 110. Rather the removable alternate memory card 145 has new firmware written thereto.

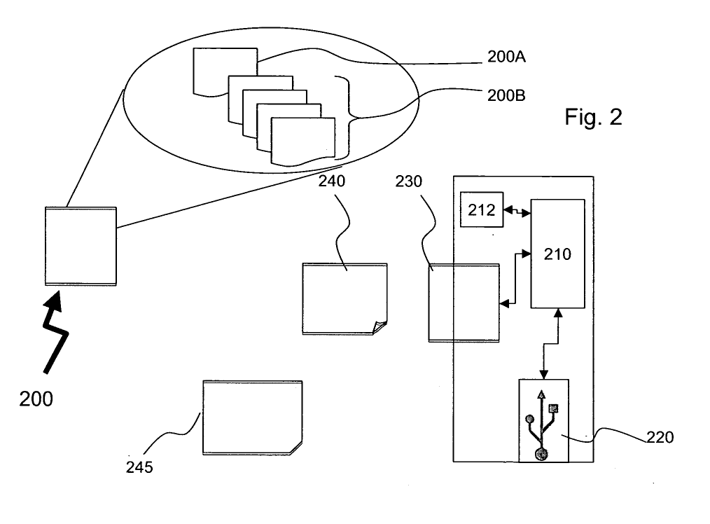

Single Encrypted Firmware: Referring to FIG. 2 shown is a portable memory storage device 200 comprising a peripheral interface in the form of a USB interface 220, a processor 210, and a secondary interface 230. The secondary interface 230 is in the form of a memory card interface, for example an interface for a Secure Digital (SD) memory card 240. Alternatively, another interface for another memory card format is used.

In practice, a SD memory card 240 is coupled with the second interface 230 and the portable memory storage device 200 is then coupled with a host system, not shown for clarity. The portable memory storage device 200 is compliant with a Universal Serial Bus standard, for example USB 1.1 or USB 2.0, operates at 5±0.25 volts and draws power from the host system. On connection to the host system the portable memory storage device 200 powers itself up, at which point the processor 210 retrieves secured firmware from within the flash memory that forms the memory of the SD memory card 240 that is inserted into secondary interface 230. Processor 210 then deciphers the secured firmware, and stores the deciphered firmware in volatile memory 212 associated with processor 210. The deciphered firmware is then executed and causes the peripheral memory storage device 200 to operate according to the design thereof. Thus, the memory card 240 has the secured firmware stored therein and insertion of different memory cards 245 into the secondary interface 230 results in the processor 210 loading and executing different encrypted firmware. For example, a firmware upgrade is provided by providing a new memory card 245. Alternatively, the memory card 245 has new firmware written thereto supporting different functionality of the portable memory storage device 200, such as encrypting all data transferred, or an alternate configuration of the portable memory storage device 200. Alternatively, some firmware is encrypted and other firmware is other than encrypted.

In this latter manner, for example, the portable memory storage device 200 is established to function in several modes of operation according to the memory card 240 or alternate memory cards 245. In a first mode, upon loading first firmware from memory card 240, the portable memory storage device 200 appears to operate as a conventional secure memory storage device, allowing storage, deleting and transfer of files in a normal course of operation to first memory block 200A, providing a storage capacity of one gigabyte (1 GB). However, unbeknownst to the user, each entry within the field allocation table (FAT) of the apparent 1 GB memory of first memory block 200A is also written to a second FAT associated with a second memory block 200B having a larger capacity, for example 4 GB. When files are deleted, they are in fact removed only from the FAT associated with the 1 GB storage area, namely first memory block 200A and are not removed from the second memory block 200B.

In a second mode of operation, a supervisor retrieves the portable memory storage device 200, provides an alternate memory card 245 to the portable memory storage device 200 thereby loading supervisory firmware thereon to the portable memory storage device 200. This supervisory firmware allows the supervisor to not only open encrypted files stored within the user accessible 1 GB first memory block 200A, but to also access data within the additional 4 GB of second memory block 200B. In this manner the supervisor is provided access to files the user of the portable memory storage device 200 has transferred to and deleted from the user accessible 1 GB memory storage area visible to them when using the portable memory storage device 200. In this manner the supervisory firmware allows the supervisor the ability to monitor the transfer activities of the employees and optionally ensures that any transferred information, whilst encrypted as per the operating requirements of the business, is accessible to the supervisor. Such a two mode portable memory storage device allows for auditing of employee and contractor activities and for monitoring compliance with corporate policies.

Optionally, the supervisory firmware performs the firmware loading in multiple steps, such as for example a two step load wherein the first step executes an authentification step requiring the supervisor to provide authentication input data that is authenticated against data stored within the alternate memory card 245 prior to loading the main firmware in the second step that provides the supervisory access functions to the first memory block 200A and the second memory block 200B.

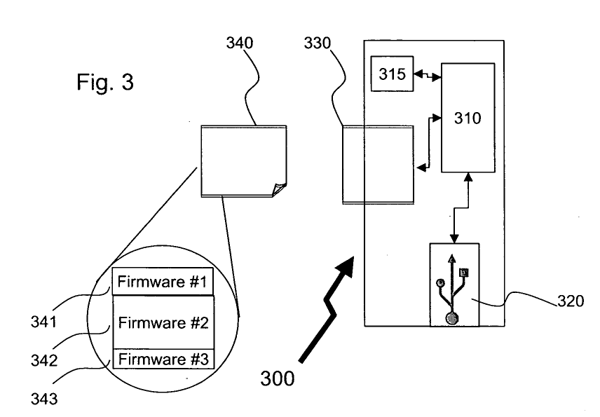

Multiple Firmwares: Referring to FIG. 3 shown is a portable memory storage device 300 comprising a peripheral interface in the form of a USB interface 320, a processor 310, and a secondary interface 330. The secondary interface 330 is in the form of a memory card interface, for example an interface for a Secure Digital (SD) memory card 340. Alternatively, another interface for another memory card format is used.

In practice, a SD memory card 340 is coupled with the secondary interface 330 and the portable memory storage device 300 is then coupled with a host system, not shown for clarity. The portable memory storage device 300 is compliant with a Universal Serial Bus standard, for example USB 1.1 and USB 2.0, operates at 5±0.25 volts and draws power from the host system. On connection to the host system the portable memory storage device 300 powers itself up and retrieves an indication of available firmware loads 341-343 stored within the memory card 340 memory and provides a user of the portable memory storage device 300 with an option to select from the available firmware loads 341-343. The user indicates a selected firmware, for example firmware load 342, and that selected firmware is retrieved and stored in a volatile memory 315 associated with processor 310. Alternatively, the user is expected to select from available firmware without being prompted. For example, a default firmware is loaded unless a predetermined key or key sequence is provided.

The selected firmware is then executed and causes the peripheral memory storage device 300 to operate according to the design thereof. Thus, the memory card 340 has the available firmware loads 341-343 stored therein and insertion of different memory cards 340 into the secondary interface 330 results in the processor 310 either loading and executing different firmware, or having available to load and execute different firmware. Advantageously, a same memory card is useful for different firmware versions of the portable device.

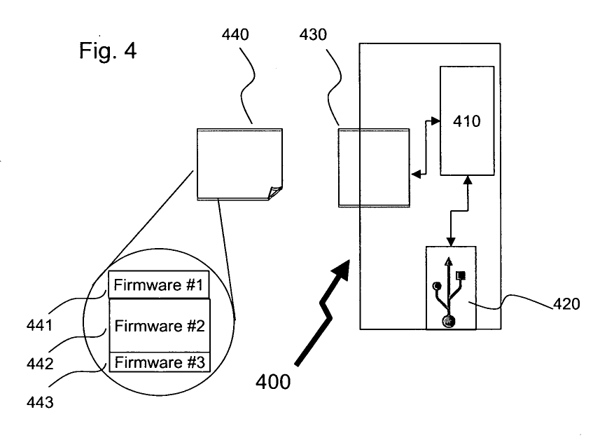

Multiple Encrypted Firmware: Referring to FIG. 4 shown is a portable memory storage device 400 comprising a peripheral interface in the form of a USB interface 420, a processor 410, and a secondary interface 430. The secondary interface 430 is in the form of a memory card interface, for example an interface for a Secure Digital (SD) memory card 440. Alternatively, another interface for another memory card format is used.

In practice, a SD memory card 440 is coupled with the secondary interface 430 and the portable memory storage device 400 is then coupled with a host system, not shown for clarity. The portable memory storage device 400 is compliant with a Universal Serial Bus standard, for example USB 1.1 and USB 2.0, operates at 5±0.25 volts and draws power from the host system. On connection to the host system the portable memory storage device 400 powers itself up and retrieves an indication of available secured firmware loads 441-443 stored within the memory card 140 memory and provides a user of the portable memory storage device 100 with an option to select from the available secured firmware loads 441-443. The user indicates a selected secured firmware, for example firmware load 442, and the selected secured firmware load 442 is retrieved, deciphered, and stored it in a memory associated with processor 410. Alternatively, the user is expected to select from available ciphered firmware without being prompted. For example, a default ciphered firmware is loaded unless a predetermined key or key sequence is provided. Further alternatively, some firmware is encrypted and other firmware is other than encrypted.

The selected deciphered firmware is then executed and causes the peripheral memory storage device 400 to operate according to the design thereof. Thus, the memory card 440 has the available secured firmware loads 441-443 stored therein and tampering with the secured firmware is difficult and/or unlikely. In addition to

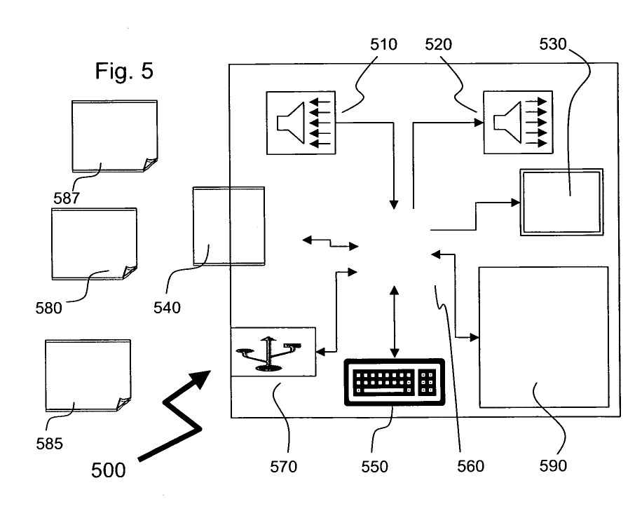

Referring to FIG. 5, shown is a multi-purpose hardware device 500 that provides a user with multiple functionalities. The multi-purpose hardware device 500 comprising a USB interface 570, a microphone 510, a data entry port 550, an audio output port 520, a display 530, a processor 560, and a memory card interface port 540. In a manner similar to the portable memory storage devices described supra in FIGS. 1 through 4 the multi-purpose hardware device 500 upon being powered on retrieves from the memory card 580 inserted into the memory card interface port 540 a firmware load for the processor 560 which is then stored in volatile memory associated with the processor 560. The firmware is then executed and causes the multi-purpose hardware device 500 to operate according to the design thereof. Thus, the memory card 580 has the firmware stored therein and insertion of different memory cards 580 into memory card interface port 540 results in the processor 560 loading and executing different firmware.

For example, a first user inserts a memory card 580 into the multi-purpose hardware device 500, and upon completion of the loading and execution of the firmware has available the functions of audio recording, via microphone 510, audio playback via audio output port 520 and display of available audio tracks on display 530. Additionally, the user is blocked from deleting information stored within the multimedia memory 590, including audio tracks they have recorded, and the USB interface 570 is disabled preventing the multi-purpose hardware device 500 from interfacing to other electronic devices for transferring data to or from the multimedia memory 590.

A second user inserts a second memory card 585 in order to use the multi-purpose hardware device 500. Loading and executing of firmware from the second memory card 585 provides a wider range of functions. The second user is able to access and display audio-visual content stored within the multimedia memory 590, download new content onto the multi-purpose hardware device 500 via the USB interface 570, and execute a word processing function with entry via data entry port 550 with the word processing application displayed on the display 530 and generated text files stored within the multimedia memory 590.

Optionally, a third user has a third memory card 587 having firmware stored therein allowing display of audio-visual information stored within the multimedia memory 590 and providing a filtering block for content such that some content is not listed as available to the user. Optionally, the firmware in allowing the user to download files from the USB interface port 570 blocks downloading of content that does not contain a valid digital rights certificate or that is filtered by the filter block, thereby preventing the user from downloading illegal copies of music tracks, albums, videos, etc. Alternatively, the firmware loads for both first memory card 580 and second memory card 585 are stored within the same physical memory card, as described supra in respect of FIGS. 3 and 4, but retrieving the firmware is performed in response to user input information other than mere selection, such user input for example including a password, PIN, or biometric information.

Alternatively in addition to firmware being retrieved the memory card, such as first memory card 580 additionally stores information such as personalized information, for example additional content specific to the user, content specified by the user, or encryption keys, passwords, etc. that are bound to the user and only released via the authentication.

Optionally, the multi-purpose hardware device 500 is supplied with memory card 580 comprising in addition to the firmware load itself information relating to the multi-purpose hardware device 500, such as for example product description, product owners manual, product type, and manufacturers serial number, and information relating to the memory itself, such as for example memory manufacturer, memory type, and personal identity. The personal identity for example being a serial number. Subsequently a user wishes to upgrade the firmware of the of the multi-purpose hardware device 500, and accesses a website associated with a vendor of firmware for the of the multi-purpose hardware device 500. This vendor is optionally the manufacturer, a value added partner, or a third party developing firmware. Upon accessing the website and inserting the memory card 580 into a memory card reader the personal identity of the memory card 580 and serial number of the multi-purpose hardware device 500 are uploaded to the website. The user then selects a firmware upgrade to acquire; this firmware upgrade is prepared for downloading to the memory card 580. The preparation for example includes ‘personalizing’ the memory upgrade with the serial number of the multi-purpose hardware device 500 and the personal identity of the memory card 580. Optionally, ‘personalizing’ limits the firmware upgrade to the memory card 580 and the multi-purpose hardware device 500 when the firmware seeks verification of each during loading and execution of the firmware load and prevents execution or limits execution in dependence upon failed verification.

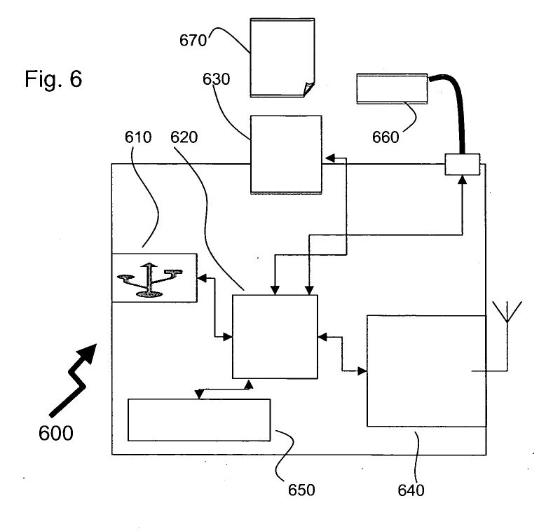

Now referring to FIG. 6, shown is a hardware security device 600 that is capable of providing computer security functions including firewall, anti-virus, anti-spy ware, intrusion detection, and intrusion prevention. The hardware security device 600 comprises a USB interface 610, Ethernet interface 660, wireless interface 640, processor 620, memory card interface 630, and internal memory 650. In operation a user wishing to employ the hardware security device 600 inserts memory card 670 into the memory card interface 630. The processor 620 recognizes the insertion of memory card 670 retrieves firmware therefrom and stores this in volatile memory associated with the processor 620. Operation of the hardware security device 600 is now governed by the firmware loaded, such that for example a first user is granted only “wired” access wherein the hardware security device 600 is connected to a USB port of their computer, not shown for clarity, via USB interface 610 and an Ethernet port, for example on their router or network access point, via the Ethernet interface 660. In this manner the hardware security device 660 monitors the user's Internet connection as an inline firewall, sitting between their computer and the network, and has disabled wireless interface 640.

A second user, inserting a second other memory card 670, is granted only “wireless” access such that now all data traffic is directed through the wireless interface 640, and the Ethernet interface 660 is disabled. Optionally a third user inserting a third memory card 670 having third firmware stored therein is provided both “wired” and “wireless” access such that both wireless interface 640 and Ethernet interface 660 are enabled. Optionally, the firmware loaded from the memory card 670 limits the network or networks they are allowed to connect to, or limits the content they are permitted to access. Optionally, the memory card 670 has stored therein several of the multiple firmware loads, and hence access rights, and selection of the firmware load is via user selection which further optionally includes provision of appropriate user related authentication information to validate the user as having sufficient rights to access selected firmware.

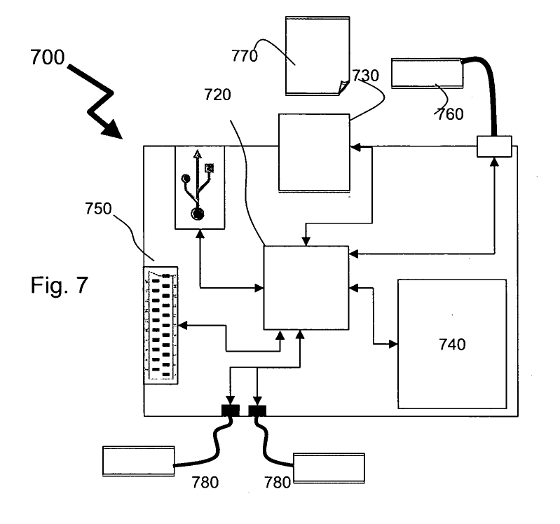

Referring to FIG. 7, shown is a gaming console 700 in the form of an Xbox 360® (console. The gaming console 700 comprises a USB interface port 710, microprocessor 720, memory card interface 730, Ethernet interface 760, memory 740, SCART connector 750, and is shown supporting controllers 780. In operation the gaming console 700 is connected to a display, for example a television, not shown for clarity, via the SCART connector 750. The gaming console supports downloading of new multimedia content via the USB interface port 710 to a computer, not shown for clarity, or online via the Ethernet interface 760, for example XBOX LIVE™ service.

A first user wishing to use the gaming console 700 provides a first memory card 770 into the memory card interface 730, and turns on the gaming console 700 whereupon the processor 720 transfers firmware from the memory card 770 to volatile memory associated with the processor 720 and executes the firmware. The gaming console 720 with this first memory card interfaced thereto operates as a conventional gaming console providing the user with the ability to select a game, retrieve the game from memory 740 and play using controller 780. The first user is also able to access an online service, for example XBOX LIVE™, and play within a multi-player game or massively multi-player online role playing game (MMPORG).

A second user accessing the gaming console 700 provides a second memory card 770 having firmware stored therein that defines the gaming console 700 as an Internet Protocol Television (IPTV) set-top box such that the second user is able to select one of the many IPTV channels available from a service provider interconnected to the gaming console via the Internet and the Ethernet port 760. In this manner the gaming console disables access to the memory 740 and controllers 780 and supports bidirectional commands across the SCART interface. A third user accessing the gaming console 700 provides a further other firmware load which establishes the gaming console 700 as a reduced function personal computer executing a Linux operating system and supporting a USB hub, not shown for clarity, interconnected to the USB interface port 710 which allows interconnection of a keyboard and pointing device. Using the reduced function personal computer the third user is able to access the Internet via the Ethernet port 760, perform online financial services etc, and utilize word processing, spreadsheet or graphics applications which are stored optionally within the memory card 770 or have been downloaded into the memory 740 of the gaming console.

Alternative configurations for the gaming console 700 using different firmware on memory card 740 include those outlined in respect of previous FIGS. 1 through 6. For example, these include providing multiple firmware loads within a same memory card, restricting access or rights based upon the firmware loaded, and restricting firmware loads based on user authentication data provided. In the specific example of the gaming console 700 other options include firmware that configures the gaming console 700 as a personal video recorder (PVR), Internet based video conferencing terminal by addition of a webcam via the USB interface port 710, and digital photographic frame wherein the display connected via the SCART connector 750 displays images stored within memory 740 when not executing other functions.

Alternatively, other consumer electronic devices are operated in accordance with the above-described embodiments. Further alternatively, the firmware is loadable at times other than power up. Optionally, the consumer electronic device is one or more of removable memory storage devices, memory storage devices, multimedia players, cameras, computer security devices, computers, gaming consoles, cellular telephones, personal digital assistants, multimedia recorders, telephones, visual display devices, facsimile machines, photocopiers, scanners, digital set-top boxes, modems, and analog set-top boxes.

Alternatively, for any embodiment described herein above wherein the firmware is not describe as encrypted, the firmware is encrypted. Optionally, encryption of firmware also enables a diversification by device such that the same firmware is “personalized” to the specific device thereby preventing software piracy via copying to other memory cards of software and distributing it. “Personalizing” firmware or software to a specific device alleviates this as other physical memory is not a same specific device. Alternatively, specific functionality may be embedded into the firmware for example to allow a limited number of copying operations, each copying operation to another memory card incorporating a “personalization” operation.

Numerous other embodiments may be envisaged without departing from the spirit or scope of the invention.

What is claimed is:

1. A method comprising:
providing an electronic product, the electronic product comprising a microprocessor, a volatile memory for storing firmware to be executed by the microprocessor, a memory card interface according to a first standard, and a communications interface according to a second standard;
inserting into the memory card interface a peripheral portable memory card according to the first standard, the peripheral portable memory card having stored thereon a firmware load;
transferring the firmware load from the peripheral portable memory card to the volatile memory of the electronic product via the memory card interface; and
using the microprocessor of the electronic product, executing the firmware load in the volatile memory so as to thereby establish a configuration of the electronic product.

2. A method according to claim 1 wherein,
providing the electronic product comprises providing the electronic product absent any firmware stored within the volatile memory.

3. A method according to claim 1 wherein,
the firmware load is stored on the peripheral portable memory card in an encrypted form.

4. A method according to claim 3 wherein,
transferring the firmware load comprises loading the encrypted firmware load, deciphering the encrypted firmware load and
storing the deciphered firmware load within the volatile memory.

5. A method according to claim 3 comprising,
deciphering the firmware load prior to execution thereof.

6. A method according to claim 4 wherein,
deciphering the firmware load is performed in dependence upon at least one of a private key stored within the memory card and user input data.

7. A method according to claim 4 wherein,
deciphering the firmware load is performed in dependence upon a private key stored within the electronic product.

8. A method according to claim 1 wherein,
the electronic product consists of a peripheral memory storage device supporting enhanced functionality.

9. A method according to claim 8 wherein,
the electronic product comprises a non-volatile memory, the non-volatile memory for storing data;
wherein executing the firmware load comprises establishing rights for at least one of reading, writing, and deleting data stored within the non-volatile memory, wherein a first firmware load establishes different rights than a second other firmware load.

10. A method according to claim 1 wherein,
wherein executing the firmware load comprises establishing rights for the communications interface.

11. A method according to claim 10 wherein,
a first firmware load establishes different rights than a second other firmware load.

12. A method according to claim 1 wherein,
the memory card has stored thereon a first firmware load and a second other firmware load and wherein one of the first firmware load and the second other firmware load is provided therefrom for execution.

13. A method according to claim 12 comprising;
providing to a user an indication of the first firmware load and the second other firmware load and receiving from the user selection data for selecting one of the first firmware load and the second other firmware load; and
transferring the selected one of the first firmware load and the second other firmware load from the memory card to the volatile memory of the electronic product for execution thereon.

14. A method according to claim 1 comprising:
deleting the firmware load from the volatile memory upon removal of the memory card.

15. A method according to claim 1 wherein the second standard is different than the first standard.

16. A method comprising:
transferring a firmware load stored on a portable peripheral memory card to a volatile memory of an electronic product via an interface in communication between the portable peripheral memory card and the electronic product, the volatile memory for storing a firmware load for execution by a microprocessor forming part of the electronic product.

17. A method according to claim 16 wherein the electronic product consists of a peripheral memory storage device supporting enhanced functionality.

18. A method according to claim 16 comprising,
executing using the microprocessor the firmware load stored in volatile memory, the firmware load establishing the configuration of the electronic product.

19. A method according to claim 18 wherein,
transferring the firmware load to the electronic device comprises transferring the firmware load upon receiving valid authentication data from a user.

20. A method comprising:
(a) providing a vendor site connected to a network, the vendor site allowing a user to browse a plurality of new functionalities, each relating to an electronic product comprising at least a first card reader and characterized by at least a serial number;
(b) interfacing a memory card associated with the user to the network, the memory card compatible with the card reader and having a personal identity;
(c) selecting from the vendor site a new functionality of the plurality of new functionalities; and
(d) transferring to the memory card from the vendor site via the network new firmware relating to the selection, the new firmware being personalized to at least one of the serial number and personal identity and when executed by the electronic product providing the selected new functionality.

21. A method according to claim 20 wherein,
at least one of (b) and (c) comprises providing a proof of ownership of the memory card by the user.

22. A method according to claim 20 wherein,
the new firmware includes a license to make a predetermined number of backup copies, each backup copy when created being personalized to the memory upon which it is stored, each backup copy absent the license element of the new firmware.

23. A method according to claim 20 comprising:
(e) transferring from the memory card to the electronic device for execution thereon the new firmware upon validating that at least one of a serial number personalizing the new firmware matches the serial number of the electronic product and a personal identity personalizing the new firmware matches the personal identity of the memory card.

24. A method according to claim 20 further comprising:
(f) erasing from the memory card the new firmware upon failing to validate at least one of a serial number personalizing the new firmware matches the serial number of the electronic product and a personal identity personalizing the new firmware matches the personal identity of the memory card.
